(19) United States
(12) Patent Application Publication
(10) Pub. No.: US 2008/0274730 A1
(43) Pub. Date: Nov. 6, 2008

(54) WIRELESS TELEPHONE SYSTEM

(75) Inventor: Siu Chung CHAN, Hongkong (CN)

Correspondence Address: EGBERT LAW OFFICES, 412 MAIN STREET, 7TH FLOOR, HOUSTON, TX, 77002, US

(73) Assignee: TECH-VISION COMMUNICATIONS Limited, Hongkong (CN)

(21) Appl. No.: 11/744,099

(22) Filed: May 3, 2007

(51) Int. Cl. H04Q 7/26

(52) U.S. Cl. 455/426.1

(57) ABSTRACT

A wireless telephone system is used to connect a plurality of cordless telephone handsets to a telephone network. The system has a short range radio module for sending and receiving telecommunication signals to and from a plurality of cordless telephone handsets, a cellular communication modules for sending and receiving telecommunication signals to and from a cellular wireless cell site, and a switch for routing telecommunications signals between the plurality of short range radio modules and the one or more cellular communication modules.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The current invention relates to wireless telephone system, and in particular a wireless telephone system that connects a large number of cordless telephone handsets to a telephone network.

2. Description of Related Art Including Information Disclosed Under 37 CFR 1.97 and 37 CFR 1.98

A private branch exchange (PBX) or private automatic branch exchange (PABX) is a telephone system used to connect a large number of telephones within an organization to a small number of external telephone lines of a public switched telephone network (PSTN). For example, a 4×20 PBX connects twenty internal lines, or extensions, installed within an organization's premises to four external lines connected to the PSTN. The operation of a PBX is well-known within the art. The PBX handles the switching of calls between telephones within the organization as well as incoming and outgoing telephone calls to and from the PSTN. A small PBX system is usually referred to as a key system.

One of the disadvantages of traditional PBX systems is their installation cost and inflexibility to adapt and change with changes in an organization to which it belongs. The PBX device must have a fixed location within the organization's premises with the external lines wired from the PSTN junction to the PBX location. The internal telephone lines must be wired from the PBX location to the individual locations within the premises where the telephones are to be located. Although such wiring is not complicated in nature, it takes time and money, to install. If there are changes within the organization, such as people moving from one location to another location or the physical location of telephones is to be changed, then the services of a telephone technician are needed. For example, each telephone line is wired to a fixed office location within the premises and has an extension, and sometimes a direct dial in (DDI) number used to identify and connect to that line. Such numbers are not easily portable within the premises, and, if a person moves from one office to another office within the premises, the they must adopt the new contact numbers of the new office or a technician must re-wire or reprogram the internal telephone line connections of the PBX so that the person can keep existing contact details at the new location.

Additionally, as the size of an organization grows, new fixed internal lines and possibly external lines must be wired to accommodate the expansion.

Accordingly, it is an object of the present invention to provide a wireless telephone system which overcomes or at least ameliorates the above-mentioned disadvantages.

### BRIEF SUMMARY OF THE INVENTION

In view of the foregoing, there is disclosed herein a wireless telephone system comprising a plurality of cordless telephone handsets and a wireless private branch exchange. The wireless private branch exchange comprises a plurality of short range radio modules for sending and receiving telecommunication signals to and from the cordless telephone handsets, one or more cellular communication modules for sending and receiving telecommunication signals to and from a cellular wireless cell site, and a switch for routing telecommunications signals between the plurality of short range radio modules and the one or more cellular communication modules.

Preferably, the wireless private branch exchange further comprises a controller for receiving requests from the short range radio and cellular communication modules and sending commands to said modules and to the switch for establishing telephone communications between the cordless telephone handsets and the cellular wireless cell site.

Preferably, the plurality of cordless telephone handsets and short range radio modules use a short range radio communications protocol selected from a group comprising DECT, DECT 6, WDCT, WiFi, and VoIP.

Preferably, the cellular communication modules use a cellular communications protocol selected from a group comprising GSM, CDMA, TDMA, WCDMA, UMTS, EDGE, WiMax and PHS.

Preferably, the wireless private branch exchange further comprises a protocol converter for converting between a cellular communications protocol and a short range radio communications protocol.

Preferably, the wireless private branch exchange comprises a greater number of the short range radio modules than of the cellular communication modules.

Further aspects of the invention will become apparent from the following description.

### BRIEF DESCRIPTION OF THE SEVERAL VIEWS OF THE DRAWINGS

An exemplary form of the present invention will now be described by way of example only and with reference to the accompanying drawings.

FIG. 1 is a schematic view illustrating an overview of a wireless telephone system according to the invention.

FIG. 2 is a block diagram illustration of a wireless private branch exchange of the telephone system of the invention.

FIG. 3 is a block diagram illustration of a cordless telephone device of a system of the invention.

### DETAILED DESCRIPTION OF THE INVENTION

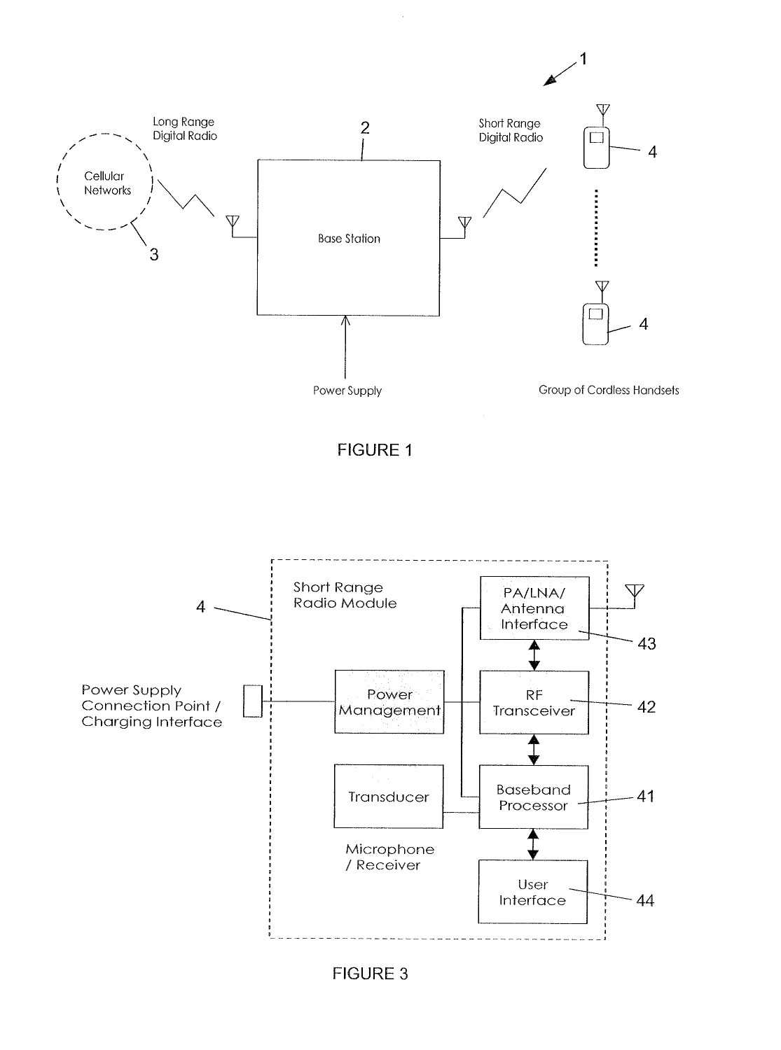

Referring to FIG. 1, the wireless telephone system 1 according to the invention comprises a wireless base station 2 that performs the functions of a private branch exchange and is wirelessly connected with a public switch telephone network (PSTN) via a cellular telephone network 3 and a plurality of cordless telephone handsets 4 in use within an organization. For the purpose of explanation only, the system will be described as one having 4 external cellular line connections and 20 internal telephone handsets or extension. This is a 4×20 system. However, this is not intended to limit the scope of use or functionality of the invention, such that more or less eternal and internal connections may be used.

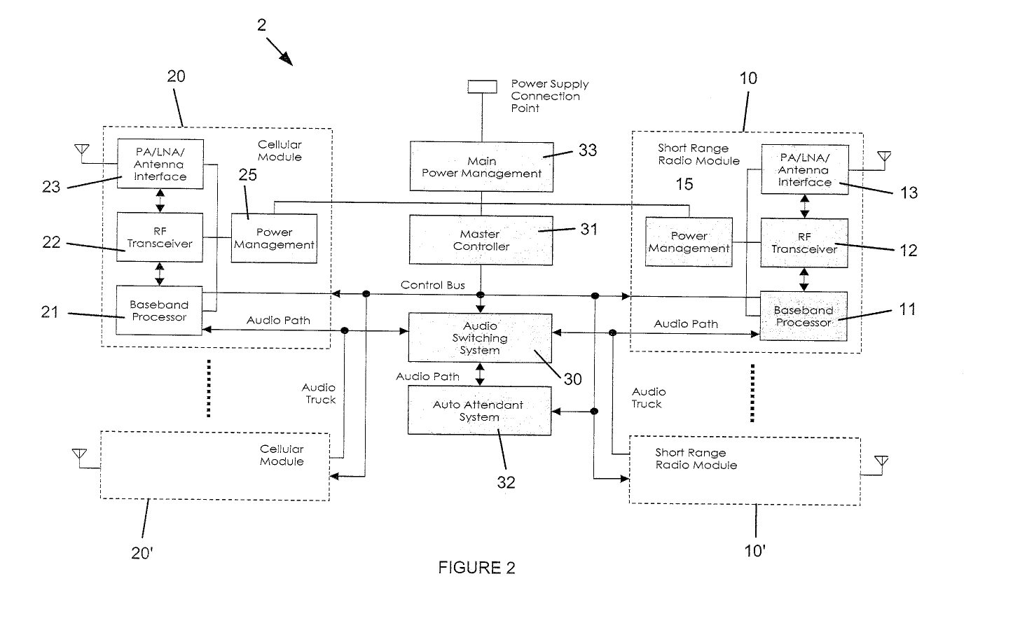

Referring to FIG. 2, the wireless base station 2 comprises a plurality of short range radio modules 10 for connecting with the cordless telephone handsets 4 and sending and receiving telecommunications signals to and from the cordless telephone handsets 4, including call requests and alerts and audio signals. Each short-range radio module 10 contains a baseband processor 11 for audio codec and module control. An RF transceiver 12 for modulation, demodulation and mixing; and a front-end block 13 including power amplifier (PA), low-noise amplifier (LNA) and antenna interface.

Each cordless telephone handset 4 also contains a baseband processor 41 for audio codec and module control. There is also an RF transceiver for modulation 42, demodulation and mixing, and a front-end block 43 including power amplifier (PA), low-noise amplifier (LNA). The handset 4 has an antenna interface and a user interface 44.

In the preferred embodiment, the wireless telephone system 1 uses the Digital Enhanced Cordless Telecommunications (DECT) short range radio communications protocol for communication between short range radio modules 10 and cordless telephone handsets 4. However, this is not intended to limit the scope or functionality of the invention, since the cordless telephone handsets 4 could operate on another protocol such as DECT 6, WDCT, WiFi, and VoIP. It is also envisaged that other short range wireless radio communication protocols are available or will become available in the future, which are suitable means for wireless communication between the cordless telephone handsets and the wireless base station modules.

Each cordless telephone handset 4 within the telephone system 1 is assigned an extension number to identify it within the system.

Each short-range radio module 10 is able to link up a maximum of six cordless telephone handsets 4 at one time, and it is envisaged that the system has one short-range radio module 10 for every six cordless telephone handsets 4 in use. In the 4×20 system, at least 4 short range radio modules allow simultaneous 4-line operation. However, this is not essential to the invention. There may be as many short range radio modules as there are cordless telephone handsets although it is unlikely that all of the cordless telephone handsets will be in operation at the same time, and therefore fewer short range radio modules will typically be used. Furthermore, some communication protocols allow simultaneous communication with more than one cordless telephone handset using a multiplexing method further reducing the number of short range radio modules required. Nonetheless, it is envisaged that there will be at least be the same number of short range radio modules as there are cellular communication modules to be described later.

The wireless base station 2 also has one or more cellular telecommunication modules 20 for communicating with a PSTN via a cellular network 3 in the vicinity of the telephone system 1. The cellular telecommunication modules 20 represent the external cellular lines of the wireless telephone system 1, and there is one cellular telecommunications module 20 for each external line required by the organization. For example in the preferred embodiment, which is a 4×20 wireless telephone system, there are four cellular communication modules which can send and receive telecommunication signals to and from a cellular wireless cell site of the cellular network for initiating and receiving telephone calls there from. As will be apparent to the skilled addressee, for operation of the external telephone calls the organization or owner of the wireless telephone system will need a separate mobile telephone connection with the cellular service provided for each external cellular line.

Each cellular communications module 20 comprises a baseband processor 21 for audio codec and module control. There is an RF transceiver 22 for modulation, demodulation and mixing, and the front-end block 23 includes a power amplifier (PA), low-noise amplifier (LNA) and antenna interface.

The cellular communication modules 10 use a cellular communications protocol appropriate to that of the cellular network in which they are to connect and operate. This could be a GSM, CDMA, TDMA, WCDMA, UMTS, EDGE, WIMAX and PHS. It is envisaged that each cellular communications module may also be provided with a Subscriber Identity Module (SIM) card for GSM network, User Identity Module (UIM) for CDMA network and Removable User Identity Module (R-UIM) for both GSM and CDMA networks.

The wireless base station 2 also includes a control module for controlling the wireless private branch exchange functions of the telephone system. In its simplest embodiment, this control module is a simple audio switch 30 for audio routing for both internal and external communications signals between the plurality of short range radio modules and the one or more cellular communications modules.

In the preferred embodiment, however, the control module also comprises a master controller 31, an auto-attendant system 32 and a power management unit 33. It also comprises a protocol converter for converting between the cellular communications protocol and a short range radio communications protocol.

The master controller 31 is the overall controlling device in the base station. It gives commands to the switching system 30 for proper audio routing, and controls the cellular modules 20 and short-range radio modules 10 for call setup, call connection, dialing and caller-ID. It also handles activation of the auto-attendant system 32 to pick up incoming calls from the cellular network 3.

The auto-attendant system 32 can be set to pick up calls automatically and serves as an attendant for all incoming calls. Callers can then be directed to the target cordless telephone by, for example, keying in the internal telephone “extension number”.

The base station 2 requires one single external power connection, which is the power supply. Typically it will be an AC adaptor for in-door use. Under special conditions battery power can be used for back-up or mobile use.

The power management system 33 provides the only external and physical connection outside the base station, and in turn, it regulates and provides DC power to the rest of the modules in the base station. There are power subsystems 15, 25 in the cellular modules 20 and the short-range radio modules 10, which are responsible for individual power management within the modules respectively. This modular approach provides flexibility of additional modules to the base station and thus enhancing the connectivity in quantities.

The advantage of the wireless telephone system is that it can be quickly and easily set up in any location within the premise of an organization which has a power supply for the device and is within reception range of a cellular network. The system is modular and can be expanded as required through the addition of cellular communications modules to extend the number of external “telephone lines” of the telephone system or short range radio modules to extend the number of cordless telephone handsets in use within the organization.

If persons within the organization move seating/office locations either temporarily or permanently, they can take with them their cordless telephone handset to keep their “assigned” extension/contact number.

With a battery power supply, the telephone system can be used in portable environments such as temporary outdoor facilities requiring multiple telephones connected to a PSTN.

It should be appreciated that modifications and alternations obvious to those skilled in the art are not to be considered as beyond the scope of the present invention.

1. A wireless telephone system comprising:
a plurality of cordless telephone handsets; and
a wireless private branch exchange comprising:
a plurality of short range radio modules for sending and receiving telecommunication signals to and from said cordless telephone handsets;
one or more cellular communication modules for sending and receiving telecommunication signals to and from a cellular wireless cell site; and
a switch for routing telecommunications signals between said plurality of short range radio modules and said one or more cellular communication modules.

2. The wireless telephone system of claim 1, wherein said wireless private branch exchange further comprises:
a controller for receiving requests from the short range radio and cellular communication modules and sending commands to the modules and to said switch, establishing telephone communications between said cordless telephone handsets and said cellular wireless cell site.

3. The wireless telephone system of claim 1, wherein said plurality of cordless telephone handsets and said short range radio modules use a short range radio communications protocol selected from a group consisting of: DECT, DECT 6, WDCT, WiFi, and VoIP.

4. The wireless telephone system of claim 1, wherein the said cellular communication modules use a cellular communications protocol selected from a group consisting of: GSM, CDMA, TDMA, WCDMA, UMTS, EDGE, WiMax and PHS.

5. The wireless telephone system of claim 1, wherein said wireless private branch exchange further comprises:
a protocol converter for converting between a cellular communications protocol and a short range radio communications protocol.

6. The wireless telephone system of claim 1, wherein the number of said short range radio modules is greater than the number of the cellular communication modules.

7. A wireless private branch exchange, comprising:
a plurality of short range radio modules for sending and receiving telecommunication signals to and from cordless telephone handsets;
one or more cellular communication modules for sending and receiving telecommunication signals to and from a cellular wireless cell site; and
a switch for routing telecommunications signals between said plurality of short range radio modules and said one or more cellular communication modules.

8. The wireless private branch exchange of claim 1, further comprising:
a controller for receiving requests from the short range radio and cellular communication modules and sending commands to the modules and said switch, establishing telephone communications between said cordless telephone handsets and said cellular wireless cell site.

9. The wireless private branch exchange of claim 1, wherein said plurality of short range radio modules use a short range radio communications protocol selected from a group consisting of: DECT, DECT 6, WDCT, WiFi, and VoIP.

10. The wireless private branch exchange of claim 1, wherein said cellular communication modules use a cellular communications protocol selected from a group consisting of: GSM, CDMA, TDMA, WCDMA, UMTS, EDGE, WiMax and PHS.

11. The wireless private branch exchange of claim 1, further comprising:
a protocol converter for converting between a cellular communications protocol and a short range radio communications protocol.

12. The wireless private branch exchange of claim 1, wherein a number of said short range radio modules is greater than the number of the cellular communication modules.

13. A wireless telephone system for connecting a plurality of cordless telephone handsets to a public switched telephone network via cellular networks, the system comprising:
a short range radio module for sending and receiving telecommunication signals to and from a plurality of cordless telephone handsets;
a cellular communication module for sending and receiving telecommunication signals to and from a cellular wireless cell site; and
a switch for routing telecommunications signals between said short range radio module and said cellular communication module.
